(19) United States
(12) Patent Application Publication
(10) Pub. No.: US 2005/0279254 A1
(43) Pub. Date: Dec. 22, 2005

(54) Cationic electrodeposition coating composition

(76) Inventors: Teruzo Toi, Osaka-fu (JP); Naotaka Kitamura, Osaka-fu (JP); Mitsuo Yamada, Osaka-fu (JP)

Correspondence Address: WENDEROTH, LIND & PONACK, L.L.P., 2033 K STREET N. W., SUITE 800, WASHINGTON, DC, 20006-1021, US

(21) Appl. No.: 11/153,552

(22) Filed: Jun. 16, 2005

(30) Foreign Application Priority Data
Jun. 16, 2004 (JP) 2004-178279

(51) Int. Cl. C08J 5/12; B01D 57/02

(52) U.S. Cl. 106/287.3; 204/502

(57) ABSTRACT

The present invention provides a cationic electrodeposition coating composition having controlled electric conductivity and controlled average particle size of the binder resin emulsion. One embodiment of the present invention provides a cationic electrodeposition coating composition comprising a binder resin emulsion, wherein the binder resin emulsion comprises; (a) amine-modified epoxy resin having an amino group, (b) blocked isocyanate curing agent, and (c) modified epoxy resin having an onium group.

### FIELD OF THE INVENTION

The present invention relates to a cationic electrodeposition coating composition having controlled electric conductivity and a controlled average particle size of a binder resin emulsion in the cationic electrodeposition coating composition.

### BACKGROUND OF THE INVENTION

A cationic electrodeposition coating method can be widely employed for undercoating an article having large surface area and complex shape, and as an automobile body, because it provides the article with coatings in detailed portions even if it has a complicated shape. The cationic electrodeposition coating method is carried out by immersing an object to be coated into a cationic electrodeposition coating composition as a cathode, and applying a voltage thereto.

Deposition of a coating film in the process of cationic electrodeposition coating is caused by electrochemical reaction, and the coating film is deposited on a surface of the object to be coated by application of voltage. Since the deposited coating film has a dielectric property, the electric resistance of the coating film will increase as the deposited layer increases in thickness by progression of the deposition of the coating film during the coating process. As the result, deposition of the coating composition onto the film-deposited sites decreases, while deposition of the coating film onto non-deposited sites starts. In this manner, the solid components of the coating composition are successively deposited to the object, thereby completing the coating. In the present specification, the property by which the coating film is successively formed onto non-coated sites of the object to be coated is referred to as “throwing power”.

To heighten merely an electric resistance of the cationic electrodeposition coating film so as to improve the throwing power induces an uprise of applied voltage. It may also cause generation of gas-pinhole due to hydrogen gas generated by electrocoating and poor appearance of the cationic electrodeposition coating film, and they are not preferable.

It is known that a surface condition of the cationic electrodeposition coating film is affected by electric conductivity of the cationic electrodeposition coating composition. Application of voltage to the cationic electrodeposition coating composition in electrocoating causes sudden decrease of electrical current shortly after the application, and thereafter the current then gradually decreases and becomes a steady current. It is as certained that discharge caused by hydrogen gas easily occurs when much amount of electrical current flows as immediately after application of voltage. By decreasing an amount of electrical current as lowering electric conductivity in an electrocoating composition when electrocoating, generation of gas-pinhole can be inhibited, that is, gas-pinhole property is improved. On the other hand, it should be noted that the lower the electric conductivity, the poorer the electric current flows at a distant locations from electrode, which causes a deterioration of throwing power. Thus, electric conductivity of the cationic electrodeposition coating composition is needed to be controlled in an optical range. Adding an electrolyte to the cationic electrodeposition coating composition can easily raise electric conductivity of the cationic electrodeposition coating composition. Therefore, providing a means for lowering electric conductivity is very useful in designing a coating composition.

A means for lowering electric conductivity is to reduce an amount of a neutralizing acid. However, it causes enlarging of a particle size of an emulsion, which is disadvantage in designing a coating composition.

A particle size of a resin emulsion and so on strongly affects stability of the electrodeposition coating composition and is one of important factors. Japanese Patent Kokai Publication No. 2001-252613 discloses that a particle size of a solid component such as a pigment in an electrodeposition coating composition affects a finished appearance such as smoothing and resistance to chipping of an electrodeposition coating film. Thus, providing a means for controlling the particle size of the solid component such as a resin component in the electrodeposition coating composition is very useful in designing a coating composition.

### OBJECTS OF THE INVENTION

The present invention is to find solutions to problems described above. A main object of the present invention is to provide a cationic electrodeposition coating composition having improved gas-pinhole property as well as stability of the coating composition and good appearance of the resulting cationic electrodeposition coating film.

### SUMMARY OF THE INVENTION

The present invention provides a cationic electrodeposition coating composition comprising a binder resin emulsion, wherein the binder resin emulsion comprises;
(a) amine-modified epoxy resin having an amino group,
(b) blocked isocyanate curing agent, and
(c) modified epoxy resin having an onium group.

It is preferred that the binder resin emulsion comprises a neutralizing acid in an amount of from 5 mg equivalent to 25 mg equivalent based on 100 parts by weight of a solid content of the binder resin emulsion.

It is also preferred that a ratio of an equivalent number of onium group to an equivalent number of amino group neutralized by a neutralizing acid in the binder resin emulsion is within a range of from 1.0:1.0 to 1.0:4.0.

It is also preferred that an average particle size of the binder resin emulsion is within a range of from 30 nm to 120 nm.

It is also preferred that the cationic electrodeposition coating composition has an electric conductivity of from 1000 to 1500 μS/cm.

The present invention also provides a process for preparing a binder resin emulsion for a cationic electrodeposition coating composition, the process comprises;
a first mixing step which comprises mixing of
   (a) amine-modified epoxy resin having an amino group,
   (b) blocked isocyanate curing agent a part of (c) modified epoxy resin having an onium group, and
   (d) neutralizing acid, and
a second mixing step which comprises adding all the remaining modified epoxy resin (c) having an onium group, to the resulting mixture, and mixing the mixture.

The cationic electrodeposition coating composition of the present invention has low electric conductivity, and has improved gas-pinhole property as well as good appearance of the resulting cationic electrodeposition coating film. The present invention can control the average particle size of the binder resin emulsion in the electrodeposition coating composition, and can provide the electrodeposition coating composition having the binder resin emulsion with the small average particle size. The present invention can also provide a means for lowering electric conductivity and a means for controlling the average particle size of the binder resin emulsion, which provides a possibility in designing a coating composition.

### DETAILED DESCRIPTION OF THE PREFERRED EMBODIMENTS

The cationic electrodeposition coating composition used in the present invention contains an aqueous solvent, binder resin emulsion dispersed or dissolved in the aqueous solvent, a neutralizing acid and an organic solvent. The cationic electrodeposition coating composition may further contain a pigment. A binder resin emulsion contains (a) an amine-modified epoxy resin having an amino group, (b) a blocked isocyanate curing agent and (c) a modified epoxy resin having an onium group.

(a) Amine-modified Epoxy Resin Having an Amino Group

(a) a amine-modified epoxy resin having an amino group used in the present invention includes an amine-modified epoxy resin. The term “amine-modified epoxy resin” represents a resin obtained by allowing a epoxy resin to react with amine whereby epoxy group thereof undergoes ring-opening and, at the same time, amino group is introduced. The amine-modified epoxy resins may be well known resins described in Japanese Patent Kokai Publication Nos. sho 54(1979)-4978, sho 56(1981)-34186 and the like.

The amine-modified epoxy resin (a) are typically made by opening all epoxy rings of a bisphenol epoxy resin with an amine compound; or by opening a part of the epoxy rings with the other activated hydrogen compound and opening the residual epoxy rings with an amine compound.

Examples of the bisphenol epoxy resins include bisphenol A type epoxy resins and bisphenol F type epoxy resins. Examples of the bisphenol A type epoxy resins, which are commercially available from Yuka Shell Epoxy Co., Ltd., include Epikote 828 (epoxy equivalent value: 180 to 190), Epikote 1001 (epoxy equivalent value: 450 to 500), Epikote 1010 (epoxy equivalent value: 3000 to 4000) and the like. Examples of the bisphenol F type epoxy resins, which are commercially available from Yuka Shell Epoxy Co., Ltd., include Epikote 807 (epoxy equivalent value: 170) and the like.

Oxazolidone ring containing epoxy resin having the following formula 1; 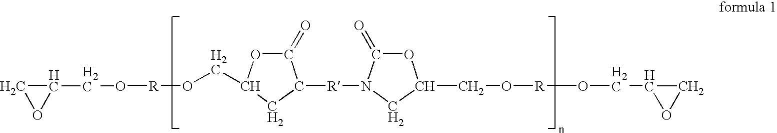
wherein, R represents a residual group obtained by removing glycydyl group from diglycidyl epoxy compound,
R′ represents a residual group obtained by removing isocyanate group from diisocyanate compound, and
n represents a positive integer;
   may be used as the (a) amine-modified epoxy resin. The oxazolidone ring containing epoxy resin can provide the cationic electrodeposition coating composition which can make a coating film having excellent heat resistance and corrosion resistance. The epoxy resin is disclosed in Japanese Patent Kokai Publication No. Hei 5(1993)-306327. Japanese Patent Kokai Publication No. Hei 5(1993)-306327 is a priority patent application of U.S. Pat. No. 5,276,072, which is herein incorporated by reference.

A method of introducing the oxazolidone ring into the epoxy resin includes a method comprising the steps of heating the blocked isocyanate curing agent blocked with lower alcohol such as methanol and polyepoxide under basic catalyst and keeping its heating temperature constant, and distilling off the by-product lower alcohol from the system.

The particularly preferred epoxy resin is an oxazolidone ring containing resin. Using the oxazolidone ring containing resin can provide the coating film which is superior in heat resistance, corrosion resistance and impact resistance.

It is well known that the epoxy resin containing oxazolidone ring can be obtained by reaction of bifunctional epoxy resin with diisocyanate blocked with monoalcohol (that is, bisurethane). The specific examples of the oxazolidone ring containing epoxy resin and the preparing method thereof are disclosed in paragraphs [0012] to [0047] of Japanese Patent Kokai Publication No. 2000-128959, which are well known. Japanese Patent Kokai Publication No. 2000-128959 is a priority patent application of U.S. Pat. No. 6,664,345, which is herein incorporated by reference.

The epoxy resin may be modified with suitable resins, such as polyesterpolyol, polyetherpolyol, and monofuctional alkylphenol. In addition, the epoxy resin can be chain-extended by the reaction of epoxy group with diol or dicarboxylic acid.

It is desired for the epoxy resin to be ring-opened with activated hydrogen compound such that they have an amine equivalent value of 0.3 to 4.0 meq/g after ring opening, and particularly 5 to 50% thereof is primary amino group.

A typical example of the activated hydrogen compounds, into which a cationic group can be introduced, includes primary amine or secondary amine. A reaction of the epoxy resin with a secondary amine provides an amine-modified epoxy resin having tertiary amino group. A reaction of the epoxy resin with a primary amine provides an amine-modified epoxy resin having secondary amino group. A reaction of the epoxy resin with a resin having primary amino group and secondary amino group provides an amine-modified epoxy resin having primary amino group. In case of using a resin having primary amino group and secondary amino group, the amine-modified epoxy resin can be prepared by the method including the following steps;
blocking primary amino group of the resin having primary amino group and secondary amino group with a ketone to produce a ketimine before reacting with the epoxy resin,
introducing the ketimine into the epoxy resin, and
deblocking the ketone to produce the amine-modified epoxy resin having primary amino group.

The specific example of the primary amine, the secondary amine and the ketimine includes butylamine, octylamine, diethylamine, dibutylamine, methylbutylamine, monoethanolamine, diethanolamine, N-methylethanolamine, as well as secondary amines obtained by blocking primary amines, such as ketimine of aminoethylethanolamine, diketimine of diethylenetriamine. The amines may be used in combination.

The amine-modified epoxy resin (a) having an amino group may be prepared by using the primary amine and/or the secondary amine as described above. Amino group which the resin (a) may have includes primary amino group, secondary amino group and tertiary amino group, and the resin (a) has one or more the amino groups.

(c) Modified Epoxy Resin Having an Onium Group

(c) modified epoxy resin having an onium group according to the present invention is a resin which assists emulsification of the binder resin. The modified epoxy resin (c) having an onium group includes for example a modified epoxy resin having quaternary ammonium group and a modified epoxy resin having tertiary sulfonium group.

The modified epoxy resin having a quaternary ammonium group is a resin which may be obtained by reacting an epoxy resin with a tertiary amine.

A typical example of the epoxy resin may be polyepoxide. The polyepoxide may preferably have an average of two or more 1,2-epoxy groups in one molecule. The polyepoxide may preferably have an epoxy equivalent of 180 to 1000, especially of 375 to 800. When the epoxy equivalent is less than 180, electrodeposition may not form film and a coating film may not be obtained. When the epoxy equivalent is more than 1000, the resin may have insufficient water solubility because of lack of an amount of onium group in one molecule.

A useful example of the polyepoxide includes the epoxy resin as described above. The oxazolidone ring containing epoxy resin may be used as the epoxy resin.

When the epoxy resin has a hydroxyl group, a half blocked isocyanate may be reacted with the hydroxyl group of the resin to form an urethane-modified epoxy resin having a blocked isocyanate group.

The half blocked isocyanate used for the reaction of the epoxy resin can be prepared by partially blocking an organic polyisocyanate with a blocking agent. The reaction of the organic polyisocyanate with the blocking agent may preferably be conducted by adding the blocking agent dropwise to the organic polyisocyanate under the condition of cooling to a temperature of 40 to 50° C. with stirring, optionally in the presence of tin catalyst.

The polyisocyanate can be anyone as long as it has an average of two or more isocyanate groups. A typical example of the polyisocyanate includes a polyisocyanate which may be used for preparing the blocked isocyanate curing agent as described below.

Suitable blocking agent for preparing the half blocked isocyanate includes lower aliphatic alkyl monoalcohol having 4 to 20 carbon atoms. A typical example of the blocking agent includes butyl alcohol, amyl alcohol, hexyl alcohol, 2-ethylhexyl alcohol, heptyl alcohol or the like.

The reaction of the epoxy resin with the half blocked isocyanate may be preferably conducted at a temperature of 140° C. and keeping the temperature at least one hour.

The tertiary amine using for the preparation of the modified epoxy resin having an onium group may preferably have 1 to 6 carbon atoms and a hydroxyl group. A typical example of the tertiary amine includes dimethylethanolamine, trimethylamine, triethylamine, dimethylbenzylamine, diethylbenzylamine, N,N-dimethyl cyclohexylamine, tri-n-buthylamine, diphenethylmethylamine, dimethylaniline or N-methylmorpholine or the like as tertiary amine as explained.

A neutralizing acid used by mixing with the tertiary amine is not limited, but includes inorganic acids or organic acids, such as hydrochloric acid, nitric acid, phosphoric acid, formic acid, acetic acid, lactic acid or the like. The resulting salt of the tertiary amine with the neutralizing acid may be reacted with the epoxy resin in a conventional method. An embodiment of a method of preparing the emulsifying resin includes the step of;
dissolving the epoxy resin in an organic solvent such as ethyleneglycol monobuthylether,
heating the resulting solution at a temperature of 60 to 100° C., and
adding the neutralizing salt of the tertiary amine to the reaction mixture and keeping the reaction mixture at a temperature of 60 to 100° C. until the reaction mixture has an acid number of 1.

The modified epoxy resin having tertiary sulfonium group may be obtained by reacting an epoxy resin in a similar way except using a sulfide instead of the tertiary amine. A usable example of the sulfide includes, for example, an aliphatic sulfide, a sulfide having aliphatic and aromatic groups, an aralkyl sulfide, a cyclic sulfide or the like. A specific example of the sulfide includes diethylsulfide, dipropylsulfide, dibuthylsulfide, diphenylsulfide, dihexylsulfide, ethylphenylsulfide, tetramethylenesulfide, pentamethylenesulfide, tiodiethanol, tiodipropanol or tiodibutanol.

The modified epoxy resin (c) having an onium group may be used alone or in combination of two or more. Preferable modified epoxy resin (c) having an onium group is the modified epoxy resin having a quaternary ammonium group, because the resin has excellent dispersibility.

(b) Blocked Isocyanate Curing Agent

Polyisocyanate used as the blocked isocyanate curing agent of the present invention is a compound having at least two isocyanate groups in one molecular. The polyisocyanates may be anyone of aliphatic type, cycloaliphatic type, aromatic type or aromatic-aliphatic type.

Examples of the polyisocyanates include aromatic diisocyanates, such as tolylene diisocyanate (TDI), diphenylmethane diisocyanate (MDI), p-phenylene diisocyanate and naphthalene diisocyanate; aliphatic diisocyanates having 3 to 12 carbon atoms, such as hexamethylene diisocyanate (HDI), 2,2,4-trimethylhexane diisocyanate and lysine diisocyanate; cycloaliphatic diisocyanates having 5 to 18 carbon atoms, such as 1,4-cyclohexane diisocyanate(CDI), isophorone diisocyanate (IPDI), 4,4′-dicyclohexylmethane diisocyanate (hydrogenated MDI), methylcyclohexane diisocyanate, isopropylidenedicyclohexyl-4,4′-diisocyanate and 1,3-diisocyanatomethylcyclohexane (hydrogenated XDI), hydrogenated TDI, 2,5- or 2,6-bis(isocyanate methyl)-bicyclo [2.2.1]heptane (referred to as norbornane diisocyanate); aliphatic diisocyanates having aromatic ring, such as xylylene diisocyanate (XDI) and tetramethylxylylene diisocyanate (TMXDI); modified compounds thereof (such as urethane compound, carbodiimide, urethodion, urethonimine, biuret and/or isocyanurate modified compound); and the like. The polyisocyanate may be used alone or in combination of two or more.

Adducts or prepolymers obtained by reacting the polyisocyanate with polyalcohols such as ethylene glycol, propylene glycol, trimethylolpropane and hexanetriol at a NCO/OH ratio of not less than 2 may also be used as the blocked isocyanate curing agent.

The block agent is a compound which can adduct to polyisocyanate group to be stable at room temperature, but reproduce free isocyanate group by heating to a temperature more than a dissociation temperature.

The blocking agent can be β-caprolactam and ethylene glycol monobutyl ether (butyl cellosolve)that are usually used.

Pigment

The cationic electrodeposition coating composition used in the process of the present invention may contain pigment, which has been conventionally used for a coating. Examples of the pigments include inorganic pigments, for example, a coloring pigment, such as titanium dioxide, carbon black and colcothar; an extender pigment, such as kaolin, talc, aluminum silicate, calcium carbonate, mica and clay; a rust preventive pigment, such as zinc phosphorate, iron phosphorate, aluminum phosphorate, calcium phosphorate, zinc phosphite, zinc cyanide, zinc oxide, aluminum tripolyphosphorate, zinc molybdate, aluminum molybdate, calcium molybdate, aluminum phosphomolybdate and aluminum zinc phosphomolybdate.

When the pigment is used as a component of the electrodeposition coating composition, a content of the pigment may preferably be not more than 30% by weight based on the solid components of the coating composition. The content of the pigment may be more preferably within the range of 1 to 25% by weight. If the content of the pigment is more than 30% by weight, it may induce poor horizontal appearance of the resulting cationic electrodeposition coating film because of sedimentation of the pigment.

When the pigment is used as a component of the electrodeposition coating composition, the pigment is generally pre-dispersed in an aqueous solvent at high concentration in the form of a paste (pigment dispersed paste). It is difficult to uniformly disperse the pigment at low concentration in one step because of powdery form of the pigment. The paste is generally called pigment dispersed paste.

The pigment dispersed paste is prepared by dispersing the pigment together with pigment dispersing resin varnish in an aqueous medium. As the pigment dispersing resin, cationic or non-ionic low molecular weight surfactant, or cationic polymer such as modified epoxy resin having quaternary ammonium group and/or tertiary sulfonium group can be used. As the aqueous medium, deionized water or water containing a small amount of alcohol can be used.

The pigment dispersing resin is generally used at the solid content of 20 to 100 parts by weight based on 100 parts by weight of the coating composition. The pigment dispersed paste can be obtained by mixing the pigment dispersing resin varnish with the pigment, and dispersing the pigment using a suitable dispersing apparatus, such as a ball mill or sand grind mill.

The cationic electrodeposition coating composition may optionally contains a catalyst. Specific example of the catalyst includes for example organic tin compounds such as dibutyltin dilaurate, dibutyltin oxide, dioctyltin oxide; amines such as N-methyl morpholine; lead acetate; metal salts of strontium, cobalt and cupper. The catalyst can affect a dissociation catalyst which dissociates the block agent in addition to the above components. An amount of the catalyst may preferably be from 0.1 to 6 parts by weight based on 100 parts of the solid content of the binder resin in the cationic electrodeposition coating composition.

Preparation and Application of Cationic Electrodeposition Coating Composition

The cationic electrodeposition coating composition of the present invention may be prepared by dispersing the binder resin emulsion, optional pigment dispersed paste and catalyst in an aqueous solvent. The binder resin emulsion includes the amine-modified epoxy resin (a) having an amino group, the blocked isocyanate curing agent (b) and the modified epoxy resin (c) having an onium group.

The binder resin emulsion can be prepared in any conventional ways. A preferred way includes a process for preparing a binder resin emulsion comprising;
a first mixing step which comprises mixing of
   the amine-modified epoxy resin (a) having an amino group,
   the blocked isocyanate curing agent (b)
   a part of the modified epoxy resin (c) having an onium group, and
   the neutralizing acid (d), and
a second mixing step which comprises adding all remaining the modified epoxy resin (c) having an onium group, to the resulting mixture, and mixing the mixture.

The process can provide a core-shell type binder resin emulsion whose shell part is composed of the emulsifying resin (c). The core-shell type binder resin emulsion has excellent stability even if it contains less amount of the neutralizing acid.

The ratio of an amount of the modified epoxy resin (c) having an onium group in the first mixing step to an amount of the resin (c) in the second mixing step represented by the amount of the first mixing step/the amount of the second mixing step may preferably be within the range of 0/100 to 50/50, more preferably 5/95 to 30/70. Using the modified epoxy resin (c) having an onium group in the above ratio enables controlling the average particle size of the binder resin emulsion in the preferred range.

When the neutralizing acid using the first mixing step is contained in the aqueous solvent, the neutralizing acid can neutralize the amine-modified epoxy resin to improve the dispersibility of the binder resin emulsion. Examples of the neutralizing acid include inorganic acids or organic acids, such as hydrochloric acid, nitric acid, phosphoric acid, formic acid, acetic acid and lactic acid.

An amount of the neutralizing acid used for preparation of the binder resin may preferably be from 5 mg equivalent to 25 mg equivalent, based on 100 g of the solid contents of the binder resin emulsion. The lower limit of the amount of the neutralizing acid may be more preferably 8 mg equivalent and the upper limit may be more preferably 18 mg equivalent. The solid contents of the binder resin emulsion correspond to a total of total solid contents of the amine-modified epoxy resin (a), the blocked isocyanate curing agent (b) and the modified epoxy resin (c) having an onium group. When the amount of the neutralizing acid is smaller than 5 mg equivalent, miscibility with water of the binder resin is not sufficient and causes difficulties of the binder resin dispersing in water or great degradation of stability of the binder resin emulsion. On the other hand, when the amount of the neutralizing acid is larger than 25 mg equivalent, it is difficult to control the range of electric conductivity within the preferable range, which can degrade the gas-pinhole property.

The term “amount of neutralizing acid” as used herein is a total amount of the neutralizing acid for neutralizing the amine-modified epoxy resin in emulsifying, and is represented MEQ(A), which is an equivalent number (mg) based on 100 g of the solid contents of the binder resin emulsion in the coating composition.

The binder resin emulsion having an onium group can be obtained in the above process. The binder resin emulsion having an onium group has improved dispersibility of the binder resin emulsion owing to onium group. Thus, the present invention provides the binder resin emulsion with excellent dispersion stability despite containing less amount of the neutralizing acid than that of a conventional amount. The present invention can also control electric conductivity of the cationic electrodeposition coating composition within lower range.

In binder resin emulsions, a ratio of an equivalent number of onium group to an equivalent number of neutralizable amino group in the binder resin emulsion may preferably be within a range of from 1.0:1.0 to 1.0:4.0, more preferably from 1.0:2.0 to 1.0:3.5, most preferably from 1.0:2.5 to 1.0:3.0. When the equivalent number of onium group is over the above range, deposition of the binder resin may be deteriorated because water solubility of the binder resin is too high. When the equivalent number of onium group is less than the above range, adequate improvement owing to the present invention may not be obtained. The binder resin emulsion having the above range of the equivalent number can be obtained by using the amine-modified epoxy resin (a) having an amino group and the modified epoxy resin (c) having an onium group in such an amount that the ratio of an equivalent number of onium group in (a) to an equivalent number of neutralizable amino group in (c) is within the above range.

The onium group in the binder resin emulsion can improve emulsifying effect of the binder resin. Thus, the present invention provides the binder resin emulsion with excellent dispersion stability despite containing less amount of the neutralizing acid than that of a conventional amount. The onium group in the binder resin emulsion hardly substitutes for the neutralizing acid in the amine-modified epoxy resin, which maintains an amino group in the epoxy resin less-neutralized condition. Therefore, the binder resin emulsion has excellent stability despite containing less amount of the neutralizing acid.

In the past, the cationic electrodeposition coating composition which contains the binder resin emulsion containing quaternary ammonium group has not been produced. The reason why such cationic electrodeposition coating composition has not been produced is that the cationic electrodeposition coating composition containing binder resin has too high water solubility and has inferior deposition of the coating composition and is not suitable for actual use when the amine-modified epoxy resin having quaternary ammonium group, that is obtained by modifying the epoxy resin with the tertiary amine, is used as a binder resin. In the cationic electrodeposition coating composition according to the present invention, the binder resin emulsion contains quaternary ammonium group, and the content of quaternary ammonium group is within an amount such that it causes no deterioration of deposition of the cationic electrodeposition coating composition and maintains prefer water solubility of the binder resin. The process for preparing the cationic electrodeposition coating composition which contains the binder resin emulsion containing quaternary ammonium group can provide the coating composition without the above problems.

The method for preparing the binder resin emulsion containing quaternary ammonium group within above range includes control of the solid contents of the components in the binder resin. A solid content ratio of the amine-modified epoxy resin (a) having an amino group: the modified epoxy resin (c) having an onium group can be controlled within the range of from 98:2 to 70:30.

It is desired for an amount of the blocked isocyanate curing agent to be sufficient to react with activated hydrogen containing functional group, such as primary amino group, secondary amino group, and hydroxyl group during curing to provide good cured coating film. The amount of the blocked isocyanate curing agent, which is represented by a solid content ratio of the amine-modified epoxy resin to the blocked isocyanate curing agent (amine-modified epoxy resin/curing agent), is typically within the range of preferably 90/10 to 50/50, more preferably 80/20 to 65/35.

The organic solvent is used as a solvent when synthesizing resin components, such as the amine-modified epoxy resin, blocked isocyanate curing agent, pigment dispersing resin. A complicated procedure is necessary for completely removing the solvent. The flowability of the coating film at the time of film forming is improved by containing the organic solvent in the binder resin, and the smoothness of the coating film is improved.

Examples of the organic solvents used in the cationic electrodeposition coating composition include ethylene glycol monobutyl ether, ethylene glycol monohexyl ether, ethylene glycol monoethylhexyl ether, propylene glycol monobutyl ether, dipropylene glycol monobutyl ether, propylene glycol monophenyl ether and the like. The aqueous solvent which is used for preparing the cationic electrodeposition coating composition of the present invention may contain one or more such organic solvents.

The cationic electrodeposition coating composition may contain additives for a coating, such as a plasticizer, surfactant, antioxidant and ultraviolet absorber, in addition to the above components.

Electric conductivity of the cationic electrodeposition coating composition may preferably be 1000 to 1500 μS/cm. When electric conductivity of the cationic electrodeposition coating composition is less than 1000 μS/cm, the improvement of throwing power may be inferior. When electric conductivity exceeds 1500 μS/cm, the poor appearance of the coating film due to generation of gas-pinhole may be produced. Electric conductivity can be measured, for example, by using a commercially available electric conductivity tester according to JIS K 0130 (the general rule of electric conductivity test).

An average particle size of the binder resin emulsion in the cationic electrodeposition coating composition may preferably be within a range of from 30 nm to 120 nm. The upper limit of the average particle size may be more preferably 100 nm. Using the binder resin emulsion having the average particle size within above range can retain stability of the coating composition.

The term “average particle size” is generally used to represent a grain size of the particle (e. g., whether grain size is rough or fine). Median diameter or arithmetic mean diameter in a particle having 50% by weight, surface area average size or volume surface area average size may be used as the average particle size. The average particle size as used herein represents a value measured by a laser method. The laser method is a measuring method for measuring an average particle size or a grain size distribution by dispersing a particle in a solvent and irradiating the resulting dispersion solvent with a laser beam and acquiring a resulting scattering light to calculate.

The process for preparing a binder resin emulsion according to the present invention enables controlling of the average particle size of the binder resin emulsion as well as low electric conductivity of the cationic electrodeposition coating composition. There is a conventional problem that the average particle size of the binder resin emulsion enlarges when an amount of the neutralizing acid in preparation of the binder resin emulsion is reduced. The present invention can solve the conventional problems. Using the process for preparation can provide controlling of the average particle size of the binder resin emulsion as well as low electric conductivity of the cationic electrodeposition coating composition.

The cationic electrodeposition coating composition of the present invention may preferably have electric conductivity of the cationic electrodeposition coating composition within a range of from 1000 to 1500 μS/cm and the average particle size of the binder resin emulsion within a range of from 30 nm to 120 nm.

The cationic electrodeposition coating composition of the present invention is electrocoated onto a substrate (an object to be coated) to form the electrodeposition coating film. The substrate can be anyone as long as it has electric conductivity, for example iron plate, steel plate, alminium plate, surface-treated one thereof, or a molded article thereof.

Electrocoating is carried out by applying a voltage of usually 50 to 450 V between a substrate serving as cathode and an anode. When the applied voltage is lower than 50 V, the electrodeposition becomes insufficient. On the other hand, when the applied voltage is higher than 450 V, the coating film may be broken and appearance thereof becomes unusual. The electrodeposition bath temperature may generally be controlled at 10 to 45° C. during electrocoating.

The electrodeposition process comprises the steps of immersing the substrate to be coated in an electrodeposition coating composition, and applying a voltage between the substrate as cathode and an anode to cause deposition of coating film. The period of time for applying the voltage can be generally 2 to 4 minutes, though it varies with the electrodeposition condition. The term “electrodeposition coating film” as used herein refers to an uncured coating film obtained by electrocoating before it is cured by heating. A thickness of the electrodeposition coating film may preferably be within a range of from 5 to 25 μm. When the thickness is smaller than 5 μm, rust resistance of the coating film may be not sufficiently obtained.

After completion of the electrodeposition process, the electrodeposition coating film obtained in the manner as described above is baked at a temperature of 120 to 260° C., preferably 140 to 220° C. for 10 to 30 minutes to be cured immediately or after being washed with water, thereby the cured electrodeposition coating film is formed.

### EXAMPLES

The present invention will be further explained in detail in accordance with the following examples, however, the present invention is not limited to these examples. In the examples, “part” is based on weight unless otherwise specified.

### PRODUCTION EXAMPLE 1

### Production of (b) Blocked Isocyanate Curing Agent

A reaction vessel was filled with 1250 parts of diphenylmethane diisocyanate and 266.4 parts of methyl isobutyl ketone (hereafter referred to as “MIBK”) and heated to 80° C., to which 2.5 parts of dibutyltin dilaurate was added. Then a solution obtained by dissolving 226 parts of ε-caprolactam into 944 parts of butyl cellosolve was added dropwise thereto at 80° C. for two hours. The mixture was then heated at 100° C. for four hours, and it was confirmed that an absorption based on isocyanate groups disappeared by measurement of IR spectrum. After being left to stand for cooling, 336.1 parts of MIBK was added to obtain a blocked isocyanate curing agent.

### PRODUCTION EXAMPLE 2

### Production of (a) Amine-modified Epoxy Resin Having an Amino Group

A flask equipped with a stirrer, a cooling tube, a nitrogen-introducing pipe, a thermometer, and a dropping funnel was filled with 87 parts of 2,4-/2,6-tolylene diisocyanate (ratio by weight=8/2), 85 parts of MIBK, and 0.1 part of dibutyltin dilaurate. With mixing the reaction mixture, 32 parts of methanol was dropwise added. The reaction was started at room temperature, and reached to 60° C. by exothermic heat. The reaction was mainly conducted within a range of from 60 to 65° C., and was continued until absorption based on isocyanate groups disappeared by measurement of IR spectrum.

Next, 550 parts of epoxy resin having an epoxy equivalent of 188, which had been synthesized from bisphenol A and epichlorohydrin by a known method, was added to the reaction mixture, and then the temperature was raised to 125° C. Thereafter, 1.0 part of benzyldimethylamine was added to react at 130° C. until the epoxy equivalent was 330.

Subsequently, 100 parts of bisphenol A and 36 parts of octylic acid were added, and the reaction was carried out at 120° C., whereby the epoxy equivalent became 1030. Thereafter, 107 parts of MIBK was added; the reaction mixture was cooled; 79 parts of diethanolamine was added; and the reaction was carried out at 110° C. for two hours. Thereafter, the resultant was diluted with MIBK until the non-volatile content of 80%, thereby to obtain an epoxy resin (amine-modified epoxy resin, solid resin content of 80%) having tertiary amino salt groups.

### PRODUCTION EXAMPLE 3

### Production of (c-1) Sulfonium-modified Epoxy Resin Having Sulfonium Group

A flask equipped with a stirrer, a cooling tube, a nitrogen-introducing pipe, a thermometer, and a dropping funnel was filled with 87 parts of 2,4-/2,6-tolylene diisocyanate (ratio by weight=8/2), 85 parts of MIBK, and 0.1 part of dibutyltin dilaurate. With mixing the reaction mixture, 32 parts of methanol was dropwise added. The reaction was started at room temperature, and reached to 60° C. by exothermic heat. The reaction was mainly conducted within a range of from 60 to 65° C., and was continued until absorption based on isocyanate groups disappeared by measurement of IR spectrum.

Next, 550 parts of epoxy resin having an epoxy equivalent of 188, which had been synthesized from bisphenol A and epichlorohydrin by a known method, was added to the reaction mixture, and then the temperature was raised to 125° C. Thereafter, 1.0 part of benzyldimethylamine was added to react at 130° C. until the epoxy equivalent was 330.

Subsequently, 100 parts of bisphenol A and 36 parts of octylic acid were added, and the reaction was carried out at 120° C., whereby the epoxy equivalent became 1030. Thereafter, 107 parts of MIBK was added; the reaction mixture was cooled; 52 parts of SHP-100 (1-(2-hydroxyethylthio)-2-propanol, manufactured by Sanyo Kasei Co., Ltd.), 21 parts of ion exchange water, and 39 parts of 88% lactic acid were added; and the reaction was carried out at 80° C. The reaction was continued until the acid value fell below 5, thereby to obtain an epoxy resin (with solid resin content of 80%) having tertiary sulfonium salt groups.

Thereafter, ion exchange water was added slowly for dilution. Removal of MIBK under reduced pressure yielded an sulfonium-modified epoxy resin having a solid content of 36%. The milliequivalent of salt group per 100 g resin of the solid resin components of the resin was 20.

### PRODUCTION EXAMPLE 4

### Production of (c-2) Modified Epoxy Resin Having Quaternary Ammonium Group

First, a reaction vessel equipped with a stirring apparatus, a cooling tube, a nitrogen-introducing pipe, and a thermometer was filled with 222.0 parts of isophorone diisocyanate (hereafter referred to as IPDI) and, after dilution with 39.1 parts of MIBK, 0.2 part of dibutyltin dilaurate was added to this. Thereafter, the temperature of this mixture was raised to 50° C., and 131.5 parts of 2-ethylhexanol was dropwise added with stirring in a dried nitrogen atmosphere for two hours. By suitably cooling, the reaction temperature was maintained at 50° C. This resulted in 2-ethylhexanol half-blocked IPDI (having a solid resin content of 90.0%).

Next, 87.2 parts of dimethylethanolamine, 117.6 parts of an aqueous solution of 75% lactic acid, and 39.2 parts of ethylene glycol monobutyl ether were successively added into a suitable reaction vessel, followed by stirring at 65° C. for about half an hour to prepare a quaternarizing agent.

Next, a suitable reaction vessel was filled with 710.0 parts of EPON 829 (bisphenol A-type epoxy resin manufactured by Shell Chemical Co., Ltd., epoxy equivalent: 193 to 203) and 289.6 parts of bisphenol A, followed by heating to 150 to 160° C. under nitrogen atmosphere to start an initial exothermic reaction. The reaction mixture was allowed to react at 150 to 160° C. for about one hour and then, after the resultant was cooled to 120° C., 498.8 parts of the 2-ethylhexanol half-blocked IPDI (MIBK solution) prepared in the above was added.

The reaction mixture was maintained at 110 to 120° C. for about one hour, and then 463.4 parts of ethylene glycol monobutyl ether was added. After the mixture was cooled to 85 to 95° C. to form a uniform mixture, 196.7 parts of the quaternarizing agent prepared in the above was added. After the reaction mixture was maintained at 85 to 95° C. until the acid value became 1, 964 parts of deionized water was added to complete the quaternarization in the epoxy bisphenol A resin, thereby to yield (c) modified epoxy resin having quaternary ammonium group (resin for dispersing pigments) having quaternary ammonium salt parts (solid resin content: 50%).

### PRODUCTION EXAMPLE 5

### Production of Pigment-dispersed Paste

The modified epoxy resin having quaternary ammonium group obtained in Production Example 4 was used as a pigment-dispersing resin. Into a sand grind mill, 120 parts of the modified epoxy resin obtained in Production Example 4, 2.0 parts of carbon black, 100.0 parts of kaolin, 80.0 parts of titanium dioxide, 18.0 parts of aluminum phosphomolybdate, and 221.7 parts of ion exchange water were filled, followed by dispersion until the particle size became equal to or less than 10 μm to yield a pigment paste (solid content: 48%).

### EXAMPLE 1

### Cationic Electrodeposition Coating Composition

(a) amine-modified epoxy resin having an amino group obtained in Production Example 2 (875 parts), 375 parts of the blocked isocyanate curing agent obtained in Production Example 1 were uniformly mixed in solid content ratio of 70/30. To the mixture, 2.14 parts of formic acid and 2.79 parts of acetic acid were added in such an amount that milligram equivalent value of acid based on 100 g of the binder resin emulsion solid content MEQ(A) was 8, then 98 parts of (c-2) modified epoxy resin having quaternary ammonium group obtained in Production Example 4 was added, and ion-exchanged water was slowly added for dilution. Next, 228 parts of the (c-2) modified epoxy resin having quaternary ammonium group obtained in Production Example 4 was added and mixed. After that, ion exchange water was slowly added for dilution. MIBK was removed under reduced pressure to obtain a binder resin emulsion having a solid content of 36%. An average particle size of the binder resin emulsion was 120 nm. The average particle size of the binder resin was measured by using Ratio Beam Spectrophotometer Model U-1800 produced by Hitachi High-Technologies Corporation.

The pigment-dispersed paste (210 parts) obtained in Production Example 5 was added to 1110 parts of the binder resin emulsion, then dibutyltin oxide in solid content ratio of 1 part and ion exchange water were added to obtain a cationic electrodeposition coating composition having a solid content of 20%. Electric conductivity of the cationic electrodeposition coating composition was 1000 μS/cm. A ratio of an equivalent number of onium group to an equivalent number of neutralizable amino group in the binder resin emulsion was 1.0:1.0. Electric conductivity was measured at solution temperature of 25° C. by using electric conductivity tester CM-30S produced by TOA DENPA KOGYO (now DDK-TOA CORPORATION) according to JIS K 0130 (the general rule of electric conductivity test).

### EXAMPLE 2

### Cationic Electrodeposition Coating Composition

(a) amine-modified epoxy resin having an amino group obtained in Production Example 2 (875 parts), 375 parts of the blocked isocyanate curing agent obtained in Production Example 1 were uniformly mixed in solid content ratio of 70/30. To the mixture, 3.04 parts of formic acid and 3.96 parts of acetic acid were added in such an amount that milligram equivalent value of acid based on 100 g of the binder resin emulsion solid content MEQ(A) was 12, then 60 parts of (c-2) modified epoxy resin having quaternary ammonium group obtained in Production Example 4 was added, and ion-exchanged water was slowly added for dilution. Next, 140 parts of the (c-2) modified epoxy resin having quaternary ammonium group obtained in Production Example 4 was added and mixed. After that, ion exchange water was slowly added for dilution. MIBK was removed under reduced pressure to obtain a binder resin emulsion having a solid content of 36%. An average particle size of the binder resin emulsion was 110 nm.

The pigment-dispersed paste (210 parts) obtained in Production Example 5 was added to 1110 parts of the binder resin emulsion, then dibutyltin oxide in solid content ratio of 1 part and ion exchange water were added to obtain a cationic electrodeposition coating composition having a solid content of 20%. Electric conductivity of the cationic electrodeposition coating composition was 1140 μS/cm. A ratio of an equivalent number of onium group to an equivalent number of neutralizable amino group in the binder resin emulsion was 1.0:2.3.

### EXAMPLE 3

### Cationic Electrodeposition Coating Composition

(a) amine-modified epoxy resin having an amino group obtained in Production Example 2 (875 parts), 375 parts of the blocked isocyanate curing agent obtained in Production Example 1 were uniformly mixed in solid content ratio of 70/30. To the mixture, 3.80 parts of formic acid and 4.95 parts of acetic acid were added in such an amount that milligram equivalent value of acid based on 100 g of the binder resin emulsion solid content MEQ(A) was 12, then 60 parts of (c-2) modified epoxy resin having quaternary ammonium group obtained in Production Example 4 was added, and ion-exchanged water was slowly added for dilution. Next, 140 parts of the (c-2) modified epoxy resin having quaternary ammonium group obtained in Production Example 4 was added and mixed. After that, ion exchange water was slowly added for dilution. MIBK was removed under reduced pressure to obtain a binder resin emulsion having a solid content of 36%. An average particle size of the binder resin emulsion was 95 nm.

The pigment-dispersed paste (210 parts) obtained in Production Example 5 was added to 1110 parts of the binder resin emulsion, then dibutyltin oxide in solid content ratio of 1 part and ion exchange water were added to obtain a cationic electrodeposition coating composition having a solid content of 20%. Electric conductivity of the cationic electrodeposition coating composition was 1290 μS/cm. A ratio of an equivalent number of onium group to an equivalent number of neutralizable amino group in the binder resin emulsion was 1.0:2.9.

### EXAMPLE 4

### Cationic Electrodeposition Coating Composition

(a) amine-modified epoxy resin having an amino group obtained in Production Example 2 (875 parts), 375 parts of the blocked isocyanate curing agent obtained in Production Example 1 were uniformly mixed in solid content ratio of 70/30. To the mixture, 3.76 parts of formic acid and 4.90 parts of acetic acid were added in such an amount that milligram equivalent value of acid based on 100 g of the binder resin emulsion solid content MEQ(A) was 15, then 55 parts of (c-2) modified epoxy resin having quaternary ammonium group obtained in Production Example 4 was added, and ion-exchanged water was slowly added for dilution. Next, 125 parts of the (c-2) modified epoxy resin having quaternary ammonium group obtained in Production Example 4 was added and mixed. After that, ion exchange water was slowly added for dilution. MIBK was removed under reduced pressure to obtain a binder resin emulsion having a solid content of 36%. An average particle size of the binder resin emulsion was 60 nm.

The pigment-dispersed paste (210 parts) obtained in Production Example 5 was added to 1110 parts of the binder resin emulsion, then dibutyltin oxide in solid content ratio of 1 part and ion exchange water were added to obtain a cationic electrodeposition coating composition having a solid content of 20%. Electric conductivity of the cationic electrodeposition coating composition was 1350 μS/cm. A ratio of an equivalent number of onium group to an equivalent number of neutralizable amino group in the binder resin emulsion was 1.0:3.2.

### EXAMPLE 5

### Cationic Electrodeposition Coating Composition

(a) amine-modified epoxy resin having an amino group obtained in Production Example 2 (875 parts), 375 parts of the blocked isocyanate curing agent obtained in Production Example 1 were uniformly mixed in solid content ratio of 70/30. To the mixture, 3.59 parts of formic acid and 4.68 parts of acetic acid were added in such an amount that milligram equivalent value of acid based on 100 g of the binder resin emulsion solid content MEQ(A) was 13, then 167 parts of (c-1) modified epoxy resin having an onium group obtained in Production Example 3 was added, and ion-exchanged water was slowly added for dilution. Next, 389 parts of the (c-1) modified epoxy resin having an onium group obtained in Production Example 3 was added and mixed. After that, ion exchange water was slowly added for dilution. MIBK was removed under reduced pressure to obtain a binder resin emulsion having a solid content of 36%. An average particle size of the binder resin emulsion was 110 nm.

The pigment-dispersed paste (210 parts) obtained in Production Example 5 was added to 1110 parts of the binder resin emulsion, then dibutyltin oxide in solid content ratio of 1 part and ion exchange water were added to obtain a cationic electrodeposition coating composition having a solid content of 20%. Electric conductivity of the cationic electrodeposition coating composition was 1210 μS/cm. A ratio of an equivalent number of onium group to an equivalent number of neutralizable amino group in the binder resin emulsion was 1.0:3.9.

### COMPARATIVE EXAMPLE 1

Amine-modified epoxy resin obtained in Production Example 2 (875 parts), 375 parts of the blocked isocyanate curing agent obtained in Production Example 1 were uniformly mixed in solid content ratio of 70/30. To the mixture, formic acid was added in such an amount that milligram equivalent value of acid based on 100 g of the binder resin emulsion solid content MEQ(A) was 15, then ion-exchanged water was slowly added for dilution. MIBK was removed under reduced pressure to obtain a binder resin emulsion having a solid content of 36%. An average particle size of the binder resin emulsion was 277 nm.

The pigment-dispersed paste (210 parts) obtained in Production Example 5 was added to 1110 parts of the resulting binder resin emulsion, then dibutyltin oxide in solid content ratio of 1 part and ion exchange water were added to obtain a cationic electrodeposition coating composition having a solid content of 20%. Electric conductivity of the cationic electrodeposition coating composition was 1510 μS/cm.

### COMPARATIVE EXAMPLE 2

Amine-modified epoxy resin obtained in Production Example 2 (875 parts), 375 parts of the blocked isocyanate curing agent obtained in Production Example 1 were uniformly mixed in solid content ratio of 70/30. To the mixture, formic acid was added in such an amount that milligram equivalent value of acid based on 100 g of the binder resin emulsion solid content MEQ(A) was 18, then ion-exchanged water was slowly added for dilution. MIBK was removed under reduced pressure to obtain a binder resin emulsion having a solid content of 36%. An average particle size of the binder resin emulsion was 189 nm.

The pigment-dispersed paste (210 parts) obtained in Production Example 5 was added to 1110 parts of the resulting binder resin emulsion, then dibutyltin oxide in solid content ratio of 1 part and ion exchange water were added to obtain a cationic electrodeposition coating composition having a solid content of 20%. Electric conductivity of the cationic electrodeposition coating composition was 1590 μS/cm.

### COMPARATIVE EXAMPLE 3

Amine-modified epoxy resin obtained in Production Example 2 (875 parts), 375 parts of the blocked isocyanate curing agent obtained in Production Example 1 were uniformly mixed in solid content ratio of 70/30. To the mixture, formic acid was added in such an amount that milligram equivalent value of acid based on 100 g of the binder resin emulsion solid content MEQ(A) was 20, then ion-exchanged water was slowly added for dilution. MIBK was removed under reduced pressure to obtain a binder resin emulsion having a solid content of 36%. An average particle size of the binder resin emulsion was 148 nm.

The pigment-dispersed paste (210 parts) obtained in Production Example 5.was added to 1110 parts of the resulting binder resin emulsion, then dibutyltin oxide in solid content ratio of 1 part and ion exchange water were added to obtain a cationic electrodeposition coating composition having a solid content of 20%. Electric conductivity of the cationic electrodeposition coating composition was 1620 μS/cm.

Properties of the cationic electrodeposition coating compositions obtained in the above Examples and Comparative Examples are shown in the following Table 1 and Table 2.

TABLE 1

| | Example | Example | Example | Example | Example |
|---|---|---|---|---|---|
| | 1 | 2 | 3 | 4 | 5 |
| milligram equivalent value of neutralizing acid | 8 | 12 | 15 | 15 | 13 |
| ratio of equivalent number of onium group to | 1.0/1.0 | 1.0/2.3 | 1.0/2.9 | 1.0/3.2 | 1.0/3.9 |
| equivalent number of neutralizable amino group | | | | | |
| electris conductivity (μS/cm) | 1000 | 1140 | 1290 | 1350 | 1210 |
| average particle size of binder resin emulsion (nm) | 120 | 110 | 95 | 60 | 110 |

TABLE 2

| | Comparative | Comparative | Comparative |
|---|---|---|---|
| | Example 1 | Example 2 | Example 3 |
| milligram | 15 | 18 | 20 |
| equivalent value | | | |
| of neutralizing | | | |
| acid | | | |
| ratio of | — | — | — |
| equivalent | | | |
| number of onium | | | |
| group to | | | |
| equivalent | | | |
| number of | | | |
| neutralizable | | | |
| amino group | | | |
| electris | 1510 | 1590 | 1620 |
| conductivity | | | |
| (μS/cm) | | | |
| average particle | 277 | 189 | 148 |
| size of binder | | | |
| resin emulsion | | | |
| (nm) | | | |

The results of Examples and Comparative Examples shows that the cationic electrodeposition coating composition of the present invention has low electric conductivity and has small average particle size of the binder resin emulsion.

The present invention can provide the cationic electrodeposition coating composition having controlled electric conductivity and controlled average particle size of the binder resin emulsion. The present invention also provides a very useful means for designing a coating composition for various substrates.

1. A cationic electrodeposition coating composition comprising a binder resin emulsion, wherein the binder resin emulsion comprises;
(a) amine-modified epoxy resin having an amino group,
(b) blocked isocyanate curing agent, and
(c) modified epoxy resin having an onium group.

2. A cationic electrodeposition coating composition according to claim 1, wherein the binder resin emulsion comprises a neutralizing acid in an amount of from 5 mg equivalent to 25 mg equivalent based on 100 parts by weight of a solid content of the binder resin emulsion.

3. A cationic electrodeposition coating composition according to claim 1, wherein a ratio of an equivalent number of onium group to an equivalent number of amino group neutralized by a neutralizing acid in the binder resin emulsion is within a range of from 1.0:1.0 to 1.0:4.0.

4. A cationic electrodeposition coating composition according to claim 1, wherein an average particle size of the binder resin emulsion is within a range of from 30 nm to 120 nm.

5. A cationic electrodeposition coating composition according to claim 1, which has an electric conductivity of from 1000 to 1500 μS/cm.

6. A process for preparing a binder resin emulsion for a cationic electrodeposition coating composition, the process comprises;
a first mixing step which comprises mixing of
(a) amine-modified epoxy resin having an amino group,
(b) blocked isocyanate curing agent
a part of (c) modified epoxy resin having an onium group, and
(d) neutralizing acid, and
a second mixing step which comprises adding all the remaining modified epoxy resin (c) having an onium group, to the resulting mixture, and mixing the mixture.
